(19) United States
(12) Patent Application Publication
(10) Pub. No.: US 2020/0028885 A1
(43) Pub. Date: Jan. 23, 2020

(54) ARTIFICIAL INTELLIGENCE FOR PROVIDING ENHANCED MICROBLOG MESSAGE INSERTION

(71) Applicant: International Business Machines Corporation, Armonk, NY (US)

(72) Inventors: Michael S. Gordon, Yorktown Heights, NY (US); James R. Kozloski, New Fairfield, CT (US); Clifford A. Pickover, Yorktown Heights, NY (US); Komminist Weldemariam, Nairobi (KE)

(21) Appl. No.: 16/042,474

(22) Filed: Jul. 23, 2018

(51) Int. Cl. H04L 29/06; G06N 5/04

(52) U.S. Cl. CPC H04L 65/601; G06N 5/043

(57) ABSTRACT

A system, method and program product for inserting artificial intelligence (AI) content into a user content stream in a microblog service. A system is provided that includes an AI agent builder that builds and refines an AI agent for a user based on attributes and data associated with a user; a courtship system that periodically measures an affiliation level between the user and the AI agent; and an AI content manager that provides AI content for insertion into a content stream of the user within a microblog service, wherein the AI content is curated based on the affiliation level and a triggering event detected by the AI agent.

### TECHNICAL FIELD

The subject matter of this invention relates to microblog message insertion and more particularly to microblog message insertion using artificial intelligence (AI).

### BACKGROUND

Microblogging is a common form of exchanging small elements of content such as short sentences, individual images, or video links. As with traditional blogging, microbloggers post about topics ranging from the simple, such as “what I'm doing right now,” to the thematic, such as “sports cars.” Commercial microblogs also exist to promote websites, services and products, and to promote collaboration within an organization. Common microblog platforms include TWITTER® (i.e., Twitter) and TUMBLR®.

In Twitter, microbloggers post tweets, which can be read, replied to, and/or reposted by followers. Users have a message stream in which they can select and follow any number of microbloggers. In this manner, the stream (which may also be referred to as a home feed, newsfeed, or timeline) only includes microblogs that are of interest to the user.

To date, improving the user experience by inserting unsolicited content into microblog streams has been met with disdain by most users. While users are continuously searching for interesting content, automated processes for inserting content is more often than not seen as an annoyance. For instance, microblog platforms primarily generate revenue by inserting marketing or advertising content into a user's stream. For example, Twitter utilizes “promoted tweets” which are selectively inserted in users' timelines by advertisers based a user's profile, history, behaviors, etc. Advertisers pay the platform based on the number of clickthroughs, i.e., the number of times an end user actually clicked on an advertisement. Challenges with this type of arrangement include the low clickthrough rate (on the order of 0.05%) and diminished end user experience. Despite efforts to include interesting content and more intelligently deliver targeting advertising, unsolicited content is by and large considered to be a nuisance, and simply ignored.

### SUMMARY

Aspects of the disclosure provide an artificial intelligence (AI) technology to enhance the user experience in a microblog service.

A first aspect discloses a microblog insertion system for inserting artificial intelligence (AI) content into user content streams, including: an AI agent builder that builds and refines an AI agent for a user based on attributes and data associated with a user; a courtship system that periodically measures an affiliation level between the user and the AI agent; and an AI content manager that provides AI content for insertion into a content stream of the user within a microblog service, wherein the AI content is curated based on the affiliation level and a triggering event detected by the AI agent.

A second aspect discloses a program product stored on a computer readable storage medium, which when executed by a computing system, inserts artificial intelligence (AI) content into user microblog content streams, including: program code that builds and refines the AI agent for a user based on attributes and data associated with a user; program code that periodically measures an affiliation level between the user and the AI agent; and program code that provides AI content for insertion into a content stream of the user within a microblog service, wherein the AI content is curated based on the affiliation level and a triggering event detected by the AI agent.

A third aspect discloses a method for inserting artificial intelligence (AI) content into user microblog content streams, comprising: building an AI agent for a user based on attributes and data associated with a user; periodically measuring an affiliation level between the user and the AI agent; and curating AI content for insertion into a content stream of the user within a microblog service, wherein the AI content is curated based on the affiliation level and a triggering event detected by the AI agent.

### BRIEF DESCRIPTION OF THE DRAWINGS

These and other features of this invention will be more readily understood from the following detailed description of the various aspects of the invention taken in conjunction with the accompanying drawings in which:

FIG. 1 shows a microblogging environment according to embodiments.

FIG. 2 shows an artificial intelligence agent according to embodiments.

FIG. 3 shows a flow diagram for implementing the microblogging environment according to embodiments.

FIG. 4 shows a computing system having a microblog insertion system according to embodiments.

The drawings are not necessarily to scale. The drawings are merely schematic representations, not intended to portray specific parameters of the invention. The drawings are intended to depict only typical embodiments of the invention, and therefore should not be considered as limiting the scope of the invention. In the drawings, like numbering represents like elements.

### DETAILED DESCRIPTION

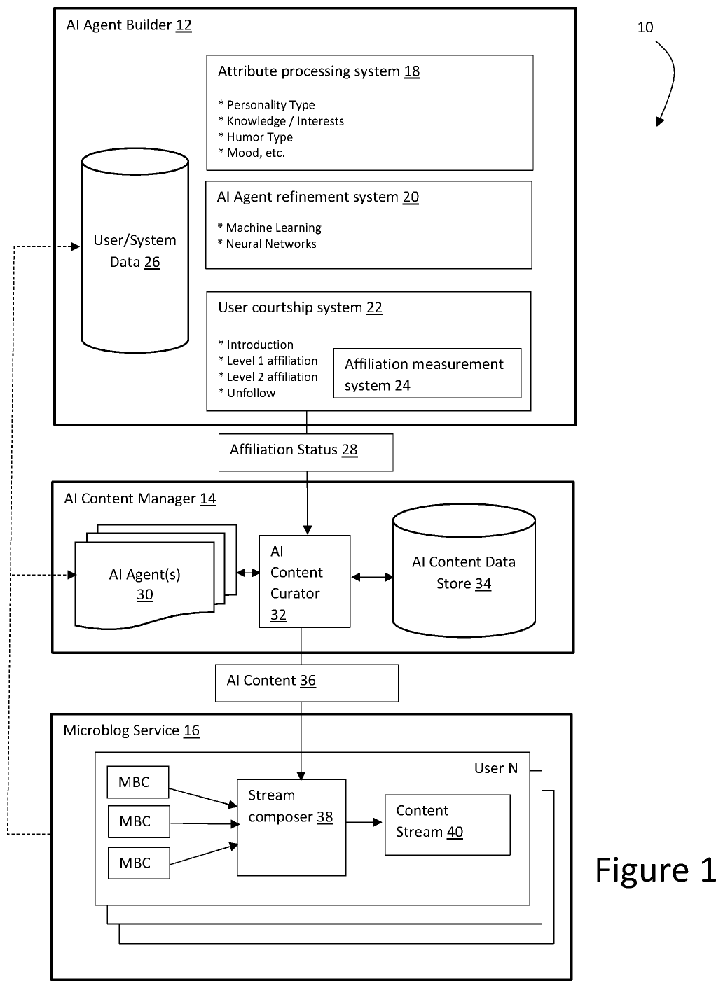

Referring now to the drawings, FIG. 1 depicts an artificial intelligence (AI) enhanced microblogging environment 10 for inserting AI based content (“AI content”) into user content streams 40. Environment 10 generally includes: (1) an AI agent builder 12 for building and refining a custom AI agent 30 for each user; (2) an AI content manager 14 that manages and curates AI related content for each user based on an affiliation level and triggering events detected from a user's associated AI agent 30; and (3) a microblog service 16 (such as Twitter) that generates unique user content streams 40 for each user based on traditional microblog content (MBC) and AI content 36 inserted by an AI Agent 30 for the associated user.

In this illustrative embodiment, AI agent builder 12 builds a customized AI agent 30 for one or more users of the microblog service 16. An AI agent 30 may be built for each platform user, for users that opt-in, for users that meet particular requirements, or for users based on any other criteria.

In this embodiment, the building process begins with an attribute processing system 18 that determines or receives a baseline set of attributes for a given user based on user/system data 26. The attributes may for example include personality type (e.g., introvert versus extrovert, etc.), interests (e.g., pets, humor, travel, etc.), knowledge (computer science, philosophy, etc.), humor type (dry, silly, etc.), overall mood (friendly, happy, angry, etc.), and so on. From the baseline set of attributes, a baseline AI agent 30 is assembled, e.g., from preconfigured attribute components. The AI agent 30 may for example include logic or rules that determines types of content to insert, frequency of insertions, and events that may trigger an insertion, etc.

User/system data 26 may for example include information and data collected from the microblog service 16 for one or more users (e.g., profile data, search history, posting history, preferences, reactions, etc.), as well as other collected data (e.g., sensor data, data from other social media platforms, behavioral data, etc.).

Once an initial baseline AI agent 30 is built, AI agent refinement system 20 periodically or continuously refines the AI agent 30 using, e.g., machine learning, neural networking, etc., based on updated user/system data 26 and/or other system information. For example, new user data may include the user response “LOL!” to a funny posted picture of a pet. Refinement system 20 may refine the AI agent 30 to increase an attribute value associated with humorous pet pictures. In another example, the same user might exhibit a level of displeasure in seeing pictures of bears posted on websites due to a previous experience with bears while camping. Refinement system 20 may refine the AI agent 20 to decrease an attribute associated with pictures of discussions of bears. In further approaches, refinement system 20 might analyze user reactions (e.g., like/dislike responses), and implement and train a neural network that predicts how the user will likely react to future content posts. The network may be trained by iteratively predicting a user's response by adjusting weights in a model and periodically refining the weights until the predicted response matches the actual response.

Once an AI agent 30 is built and deemed ready for a user, a user courtship system 22 is implemented to introduce the AI agent 30 to the user and track an affiliation measure with the user via affiliation measurement system 24. Introduction of the AI agent 30 to the user may occur in any manner. In one illustrative embodiment, the user may be automatically configured to “follow” the agent 30. An introduction may include a post such as:
“AI_Buddy: Hi, I am an AI designed specifically for you to post content that hopefully you find interesting. If you do not want to receive these posts, you can unfollow me at any time. You can also respond to and/or like/unlike my posts, which will hopefully improve our experience together.”

Assuming the AI agent 30 is not immediately unfollowed, the AI agent 30 is placed into a level 1 affiliation status, which indicates that the user should only receive basic types of AI content 36 that are highly likely to be accepted as interesting or useful by the user (e.g., content without advertisements, pictures associated with known interests of the user, jokes similar to ones the user reacted positively to, etc.) and at an acceptable frequency (e.g., every few days).

Affiliation measurement system 24 evaluates feedback regarding AI posts over time and determines an affiliation score or measure between the user and the AI agent 30. As the affiliation score grows, the affiliation level can be incremented, e.g., from a level 1 to a level 2 affiliation, which indicates that the types of AI content 36 generated and posted for the user may be expanded. For example, entertainment content with product placements may be posted into the user's stream in level 2. Additional affiliation levels (e.g., level 3, level 4, etc.) may also be achieved as the affiliation score grows even higher. Each higher affiliation level may for example allow for more and more types of content (e.g., level 3 may include highly technical content that might be of interest, movie recommendations, product and service recommendations, targeted advertising, etc.). Accordingly, as the affiliation between user and AI agent 30 increases, an expanded set of content can be inserted into the stream. This allows the user to bond with the AI agent 30 at his or her own pace, if at all.

AI content 36 may be generated in response to any type of triggering event detected by the AI agent 30, e.g., in response to a news event, based on time of day, based on volume of posts in the user stream, types of posts in the user stream, posts made by the user, detected mood, cognitive or behavior patterns of the user, group sentiments, etc.

Once a triggering event is detected, the actual selection of AI content 36 for a user is managed by the AI content manager 14, which, e.g., pulls content from an AI content data store 34 in response to parameters provided by the AI agent 30. AI content data store 34 may include content from any source, e.g., newsfeeds, other microblog posts, advertisements, published papers, books, websites, other social media apps, machine generated content, etc. The content in the data store 34 may be indexed based on a taxonomy and/or annotated with metadata. For example, a joke may be annotated with metadata that specifies the category of humor (e.g., pet humor), parental rating (e.g., G-rated), user reviews (e.g., very funny), author, etc.

In this embodiment, the AI agent 30 interfaces with an AI content curator 32 to select AI content items for the user based on AI logic defined by the AI agent 30 and the current affiliation status 28. For example, the AI agent 30 may recognize that the user and her cohorts have been posting pictures of snowy weather around a particular location, which triggers the AI content curator 32 to find related pictures. If a picture is found that meets the requirements of the current affiliation level (e.g., snowy picture, color, no advertising, etc.), the AI content 36 is pulled from the data store 34 and loaded into the stream composer 38 for the user (e.g., user N) in the microblog service 16. The AI content 36 is then mixed in with the traditional microblog content (MBC) and presented to the user via the content stream 40.

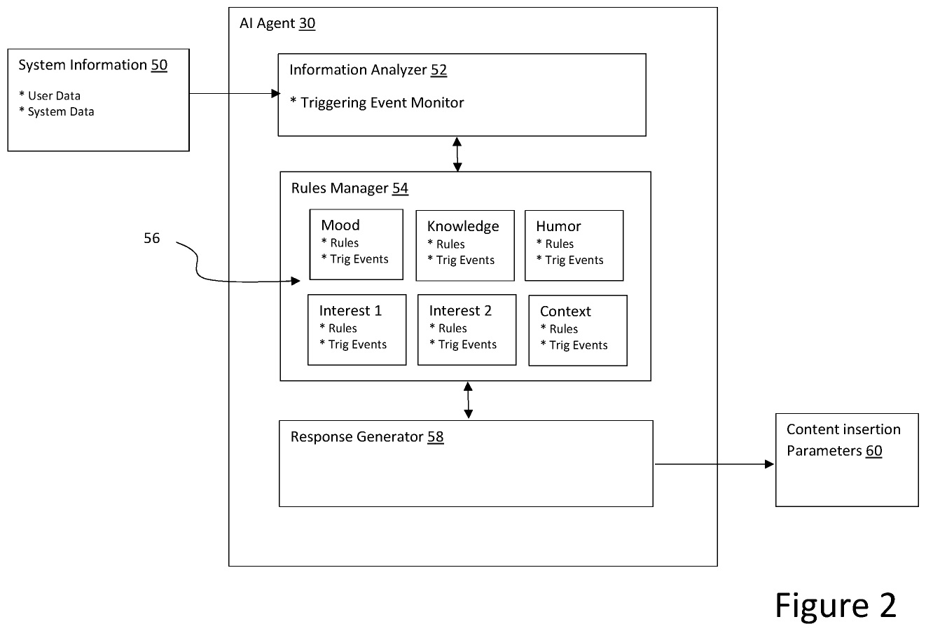

FIG. 2 depicts an example of an AI agent 30 that analyzes system information 50 and generates AI content insertion parameters 60. System information 50 may include any information such as user/system data 26 (FIG. 1), which may include information about the user, other users, the microblog service, cohorts, etc., as well as external data (e.g., weather, social media data, news, etc.), etc. Content insertion parameters 60 may for example specify a category and type of desired AI post (e.g., a humorous picture of a dog, football scores, etc.). In this illustrative embodiment, information analyzer 52 analyzes the system information 50 to detect any defined triggering events (e.g., mood change in the user, a special interest story in the news, days without a user post, a detected context, etc.). In an illustrative embodiment, the threshold of a triggering event can be adjusted. For example, if a user is interested in an upcoming royal wedding between a prince and his wife-to-be, any new related published article prior to the wedding could be a triggering event. After the wedding, the threshold might be lowered so that other news stories, pictures, and articles could be made a higher priority. Once a triggering event is detected, response generator 58 utilizes rules manager 54 to employ rules from one or more attribute groups 56 (e.g., mood, knowledge, etc.) to generate a set of content insertion parameters 60. Based on the set of content insertion parameters 60, the AI content manager 14 can curate AI content 36 for insertion into the user's content stream 40 (FIG. 1). The rules, for instance in the Knowledge attribute in rules manager 54, might include an algorithm to rate articles on self-driving cars higher than articles on gas mileage on new cars, although both areas of knowledge might be of interest to the user. The articles with the higher rating might be inserted into the user's content stream at a higher rate than those with loser rating.

The inserted AI content 36 may comprise any type of content. The content may for example comprise an extant message from another user/feed/chatbot; a generated message that is not currently extant (e.g., a machine-generated message or message sent based on a request for a message that triggers the generation of a new message by a human or messages translated from one microblogging service stream (e.g. Slack) to another (e.g. Twitter)), etc.

The triggering events may be controlled, e.g., by a desired number of unsubscribed messages allowed per unit time; a time of day, a day of the week, a time of year (e.g. season, holiday, etc.); the current weather, a user cohort (e.g., autism); a user's social network, a user cognitive state (e.g., based on a real-time assessment (e.g., of mood), a group sentiment in a particular topic (e.g., based on real-time assessment sentiment analysis), user-specified message-filtering firewall rules (e.g., based on message relevance or importance to the user), etc.

A real-time assessment of a group sentiment in a particular topic may be estimated based on analyzing messages in one or more service stream channels (e.g., a software developer community in a slack channel, a chat group, etc.).

Mood data may be driven by any of: emotion, mood, arousal, a need for excitement or relaxation, etc. Mood data can, in part, be determined by existing sensors such as Internet of Things (IoT) sensors or smart watches that can measure heart rate, perspiration, respiration, etc. Knowledge/cultural data may be based on detection of likely new knowledge, or based on a user's likely current knowledge state. If available, a user knowledge model may indicate a knowledge/skill gap in an area; historic data may indicate that a user has shown a strong engagement patterns in the past in a similar topic of the message to be inserted, etc. Additionally, a triggering event may take into account breaking news in an area of interest to the user.

Triggering events may be driven by time and/or context (e.g., diversity context, cultural context, historic sentiment/tone with respect to a first, or original, tweet/parent tweet . . . ).

In one embodiment, the decision to insert AI content may be driven by sensing the interplay of a user's cognitive and affective processes by combining evidence from multiple inputs (e.g., analyzing the tones of the messages sent-out for prior T time period, cognitive and affective signals from various native and instrumented sensors on user's computing devices, etc.). For instance, the insertion of the message may be triggered by learning an affective context of the user relevant to a microblog message (e.g., in working environment, in learning context) such as boredom, confusion, frustration, engagement etc. For example, a user may be bored with a current activity and may be losing motivation. This may trigger the insertion of AI content to create a mood modulation.

The system may further use adaptive theories to the process of modulating knowledge (e.g., learning on a mobile device) and identify cues/data-streams that can help infer affective states. Adaptive theories might include inserting a link to an article on relaxation or exercise when a user is stressed, learned from a link to the user's calendar showing a day full of meetings with clients. Finally, the message generation and insertion algorithms may take into consideration the affective context of the user to moderate the tone of the inserted message dynamically.

The inserted AI content 36 can be intended to “perk up,” or motivate a sleepy individual at work, or during exercises like walking.

The inserted message may be considered for insertion based on the desire for diversity with respect to any of: tweet length, insertion of an image/gif/video, insertion of a message from a person with a profile with a different or similar aspect with respect to the user (e.g., occupation, sports interest, skills/knowledge/interest, gender, culture, country demographic, etc.). In some sense, the user's attributes (with respect to skills, knowledge or interest) can be learned from historic messages inserted across multiple microblogging service streams (e.g., Slack, Twitter, etc.).

In instances where diversity, mood modulation, and knowledge modulation within a team, organization, or company is desired, this tool can be used to enhance communication, serendipity, and creativity in an organization. If desired, topics of tweets may easily be learned and/or estimated based on keywords, topic extraction, tags, etc. This could be especially useful for teams located at different locations as email tends to stay unread. Characteristics of the message that are considered may include any of: length, vocabulary used, topic, political cartoon, a pie chart showing statistics of an interesting subject, quotation, an artwork to elevate the spirit or trigger deep reflection, a comic, a joke, humor, etc.

If desired, the “presentation” of the inserted AI content 36 may be different for different users according to their cohort/context (e.g., chart, text, voice, etc.). Note that, optionally, the user may specify a kind of “target” for mood or knowledge modulation using a graphical user interface that includes GUI elements such as dials, sliders, menu items, etc.

In other embodiments, this system may be tailored to groups or microgroups, which may have identifications (IDs, hashtags, etc.) mentioned in the microblog message. For example, a user may be enrolled in a microgroup corresponding to the microgroup ID, and the microblog message may be sent to all member users in the microgroup. The system may foster cross-group dispersals of occasional messages in the ways we have described.

Geographical or group forms of diversity may be encouraged as useful. As one example, a crowd in which the user is located may be learned and/or estimated, where the crowd is a group of spatially proximate users, users within an organization, etc. The microblog post of the user is tagged with a crowd identifier of the crowd in which the user is located such that the microblog post includes a crowd identifier tag. Publication of the microblog post including the crowd identifier tag is then carried out, along with its dispersal for novelty insertion in other user's microblog streams. For example, the tag may be optionally shown with a tag in the form of an icon, graphic, text, etc. This might be a useful communication means to reach out to employees who might, for instance, be at a Yankees game, when an important event occurs at the office.

The system may also provide trans-vendor services so that messages from one service may be able to be inserted into the streams of other services, with permission and authorization as needed.

In another embodiment, the system may be tailored to, or restricted in some cases, to an enterprise microblog architecture, such as a corporate environment. This will foster cross-team serendipity, which has the potential to foster innovation.

The system may use one or more message or communication translation engines that facilitate the inter-channel or inter-trans-vendor communications. In one instance, a translator engine further provides a message or communication mapping service among various microblogging service streams to personalize the user desired stream and message format.

The system can also support multiple types of user interfaces, such as Web interfaces, mobile devices, portals, instant messages, etc. In an enterprise, some teams require closed communications due to concerns of confidentiality. For example, messages in an HR team would be restricted, and our system may take account of this. Various filters may be implemented so that only some teams, people, tweets, etc., may be eligible for cross-insertion in our system. If desired, in a secondary embodiment, restricted access (e.g., firewall policies/rules) to inserted messages across trans-vendor services in an enterprise setting can be facilitated via password protected channels, subscription-based channels, invitation-only channel, etc. These channels can be implemented using blockchain technology (e.g., to employ or create tamper-proof, secure, distributed records).

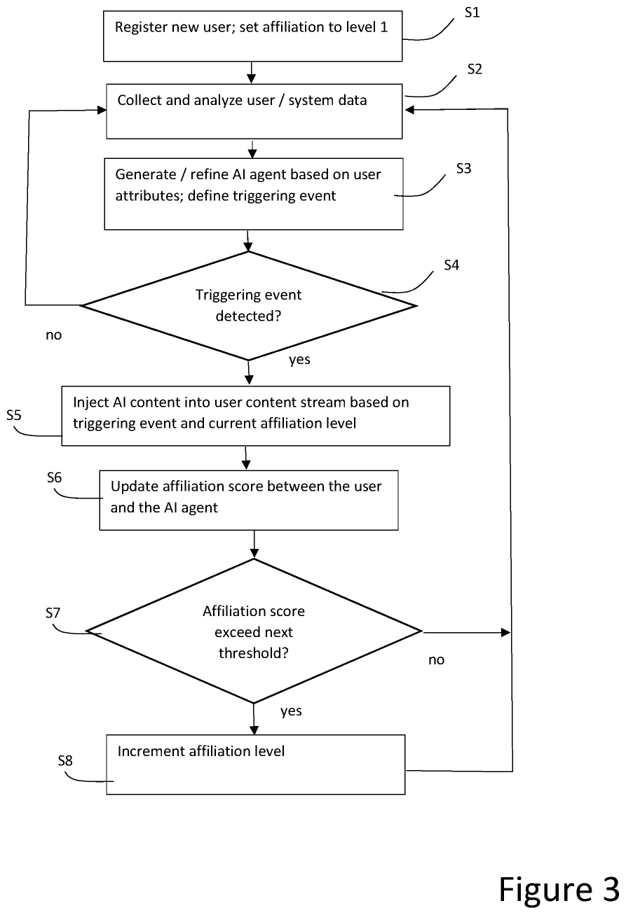

FIG. 3 depicts a flow diagram of a process of implementing the environment 10 of FIG. 1. At S1, a new user is registered with the microblog platform 16 and an affiliation is set to level 1. At S2, information regarding the user and system is collected and analyzed. Initially, data associated with the new user is analyzed to determine relevant baseline attributes of the user, based on a user profile, engagement activity, reaction history, queries, etc. Next, at S3, an AI agent 30 is generated (and later refined) based on the attributes of the user. In addition, a set of triggering events and associated priorities are defined for the AI agent 30.

At S4, a determination is made whether a triggering event is detected (and/or a threshold associated with a triggering event is exceeded). If no, then user/system data is further collected and analyzed at S2 and the AI agent 30 is refined. If a triggering event is detected at S4, then AI content 36 is inserted into the user content stream 40 based on the triggering event and current affiliation level at S5. Initially, as noted, the affiliation level is set to 1 so the AI content 36 for insertion has a high probability of approval by the user (e.g., a joke, a picture, a timely article, etc.). At S6, an affiliation score between the user and the AI agent 30 is calculated/updated. The affiliation score may be updated based on a reaction such as a like/dislike response, a lack of response, a written response, a reposting, a mood change, etc. The affiliation score may be determined over time based on an accumulation of reactions, e.g., based on number of positive reactions (liking, reposting, etc.) versus negative reactions (lack of response, dislike, etc.) over a 10 day period. Thus for example, 15 positive reactions and 12 negative reactions over the time period would result in a net positive score of 3. Additionally, the affiliation score may be influenced with sensor information, e.g., facial recognition sensing a smile, a frown, heat, heart rate, body movement, etc.

At S7, a determination is made whether the updated affiliation score exceeds a next threshold. For example, a threshold may be defined as 20 net positive reactions over the past week. If the threshold is exceeded, then the affiliation level between the user and AI agent 30 is incremented at S8, e.g., to level 2. A level 2 affiliation may for example allow for a broader level of content, including entertainment options, advertising, etc. Regardless of whether the threshold is met at S7, the process loops back to S2 where user and system data are further collected and analyzed and the process repeats. Using this approach, the user is not initially put off by the AI agent 30, but instead is allowed to create an affinity with the AI agent 30 over time as trust builds. As the affiliation levels increment, more and more different types of content can be directed to the user without the user becoming annoyed.

The environment 10 (FIG. 1) thus provides a microblogging AI agent 30 tailored to the cognitive contexts and moods of the user, and which is able to retweet or post microblog entries to that user in response to these contexts/moods. In creating a helpful AI agent 30, for example with a fun name like “AI_Buddy,” the microblogging AI agent 30 becomes accepted into the stream of the user. Because it is known that the agent is artificial, the user will expect it to provide content that is not human in origin, for example targeted advertising. In one approach, by distancing the agent from the company running the microblog service, the AI agent 30 can gain acceptance for advertising in the user's stream.

For example, James follows Cliff on Twitter. Because James is known to smile whenever he reads Cliff's tweets depicting humor, the AI agent 30 determines that retweeting humorous photos with wry captions are desirable to James. The agent, which introduced itself to James with the name “AI_Buddy” and begins adding retweets to James's feed from Cliff and other microbloggers. In this way, James begins to like and accept AI_Buddy. Soon thereafter, when in increased affinity level is established, AI_Buddy on occasion tweets advertising relevant to the humorous tweet. James is more likely to accept this advertising because it is: not inserted by the microblogging company, but instead by AI_Buddy; not corrupting the microblogs of Cliff, only those of AI_Buddy; and is relevant to content that James would have missed otherwise without AI_Buddy's help.

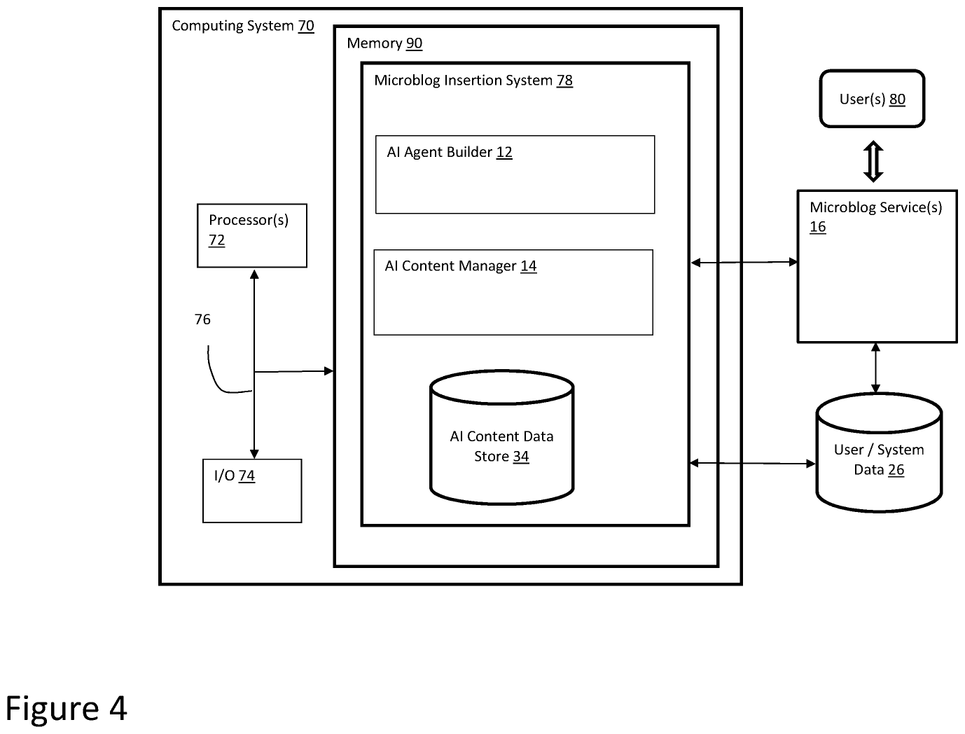

FIG. 4 depicts a computing system 70 having a microblog insertion system 78, which include AI agent builder 12, AI content manager 14 and AI content data store 34. Microblog insertion system 78 interfaces with one or more microblog services 16 as well as user/system data 26 associated with the service(s) 16. Accordingly, when a user 80 engages with a microblog service, the microblog insertion system 78 can operate in the background in a seamless manner.

It is understood that microblog insertion system 78 may be implemented as a computer program product stored on a computer readable storage medium. The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Java, Python, Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

Computing system 70 may comprise any type of computing device and for example includes at least one processor 72, memory 90, an input/output (I/O) 74 (e.g., one or more I/O interfaces and/or devices), and a communications pathway 76. In general, processor(s) 72 execute program code which is at least partially fixed in memory 90. While executing program code, processor(s) 72 can process data, which can result in reading and/or writing transformed data from/to memory and/or I/O 74 for further processing. The pathway 76 provides a communications link between each of the components in computing system 70. I/O 74 can comprise one or more human I/O devices, which enable a user to interact with computing system 70. Computing system 70 may also be implemented in a distributed manner such that different components reside in different physical locations.

Furthermore, it is understood that the microblog insertion system 78 or relevant components thereof (such as an API component, agents, etc.) may also be automatically or semi-automatically deployed into a computer system by sending the components to a central server or a group of central servers. The components are then downloaded into a target computer that will execute the components. The components are then either detached to a directory or loaded into a directory that executes a program that detaches the components into a directory. Another alternative is to send the components directly to a directory on a client computer hard drive. When there are proxy servers, the process will select the proxy server code, determine on which computers to place the proxy servers' code, transmit the proxy server code, then install the proxy server code on the proxy computer. The components will be transmitted to the proxy server and then it will be stored on the proxy server.

The foregoing description of various aspects of the invention has been presented for purposes of illustration and description. It is not intended to be exhaustive or to limit the invention to the precise form disclosed, and obviously, many modifications and variations are possible. Such modifications and variations that may be apparent to an individual in the art are included within the scope of the invention as defined by the accompanying claims.

What is claimed is:

1. A microblog insertion system for inserting artificial intelligence (AI) content into user content streams, comprising:
an AI agent builder that builds and refines an AI agent for a user based on attributes and data associated with a user;
a courtship system that periodically measures an affiliation level between the user and the AI agent; and
an AI content manager that provides AI content for insertion into a content stream of the user within a microblog service, wherein the AI content is curated based on the affiliation level and a triggering event detected by the AI agent.

2. The microblog insertion system of claim 1, wherein the affiliation level is determined based on reactions of the user in response to AI content.

3. The microblog insertion system of claim 2, wherein a higher affiliation level allows for an expanded set of AI content relative to a lower affiliation level.

4. The microblog insertion system of claim 1, wherein the AI agent defines a set of triggering events and rules for generating responses to detected triggering events.

5. The microblog insertion system of claim 1, wherein the triggering event is selected from a group consisting of: a time, a detected mood of the user, a context, and a user cohort.

6. The microblog insertion system of claim 1, wherein the triggering event comprises one of:
a detected mood of the user and a resulting AI content is curated to modulate the mood of the user; or
a detected knowledge state of the user and resulting AI content is curated to modulate the knowledge state of the user.

8. A program product stored on a computer readable storage medium, which when executed by a computing system, inserts artificial intelligence (AI) content into user microblog content streams, comprising:
program code that builds and refines an AI agent for a user based on attributes and data associated with a user;
program code that periodically measures an affiliation level between the user and the AI agent; and
program code that provides AI content for insertion into a content stream of the user within a microblog service, wherein the AI content is curated based on the affiliation level and a triggering event detected by the AI agent.

9. The program product of claim 8, wherein the affiliation level is determined based on reactions of the user in response to AI content.

10. The program product of claim 9, wherein a higher affiliation level allows for an expanded set of AI content relative to a lower affiliation level.

11. The program product of claim 8, wherein the AI agent defines a set of triggering events and rules for generating responses to detected triggering events.

12. The program product of claim 8, wherein the triggering event is selected from a group consisting of: a time, a detected mood of the user, a context, and a user cohort.

13. The program product of claim 8, wherein the triggering event comprises one of:
a detected mood of the user and a resulting AI content is curated to modulate the mood of the user; or
a detected knowledge state of the user and resulting AI content is curated to modulate the knowledge state of the user.

14. The program product of claim 8, wherein the triggering event comprises a detected interest of the user and a resulting AI content includes content associated with the detected interest.

15. A method for inserting artificial intelligence (AI) content into user microblog content streams, comprising:
building an AI agent for a user based on attributes and data associated with a user;
periodically measuring an affiliation level between the user and the AI agent; and
curating AI content for insertion into a content stream of the user within a microblog service, wherein the AI content is curated based on the affiliation level and a triggering event detected by the AI agent.

16. The method of claim 15, wherein the affiliation level is determined based on reactions of the user in response to AI content.

17. The method of claim 16, wherein a higher affiliation level allows for an expanded set of AI content relative to a lower affiliation level.

18. The method of claim 15, wherein the AI agent defines a set of triggering events and rules for generating responses to detected triggering events.

19. The method of claim 15, wherein the triggering event is selected from a group consisting of: a time, a detected mood of the user, a context, and a user cohort.

20. The method of claim 15, wherein the triggering event comprises one of:
a detected mood of the user and a resulting AI content is curated to modulate the mood of the user; or
a detected knowledge state of the user and resulting AI content is curated to modulate the knowledge state of the user.
